(19) United States
(12) Patent Application Publication
(10) Pub. No.: US 2018/0089770 A1
(43) Pub. Date: Mar. 29, 2018

(54) PREDICTIVE CUSTOMIZATION OF FOOD SERVICE OPERATIONS THROUGH VISUALIZED SERVICE SETTINGS

(71) Applicant: International Business Machines Corporation, Armok, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN)

(73) Assignee: International Business Machines Corporation, Armonk, NY (US)

(21) Appl. No.: 15/279,878

(22) Filed: Sep. 29, 2016

(51) Int. Cl. G06Q 50/12; G06N 5/02

(52) U.S. Cl. CPC G06Q 50/12; G06N 5/022

(57) ABSTRACT

A muscle movement data is analyzed to determine a pattern of movement. The muscle movement data is collected from a user at a location using a sensor. The pattern of movement is correlated to a manner of using a dinnerware. A set of aspects is calculated, the set of aspects being indicative of a circumstance of using the dinnerware. A preference profile is constructed for the user, the preference profile including an identity of the user, an identifier associated with the dinnerware, and the set of aspects. A knowledgebase of preference profiles is updated with the profile, where the knowledgebase is configured to predict a dinnerware preference of the user during a future dining circumstance of the user.

### TECHNICAL FIELD

The present invention relates generally to a method, system, and computer program product for improving customer service in the food service industry by predicting a user's service preferences. More particularly, the present invention relates to a method, system, and computer program product for predictive customization of food service operations through visualized service settings.

### BACKGROUND

A wireless data processing system, a wireless data communication device, or a wireless computing platform is collectively and interchangeably referred to herein as “mobile device” or “device”. For example, many mobile devices not only allow the users to make voice calls, but also exchange messages and data, access remote data processing systems, determine a user's location or activity, communicate with other mobile devices or data processing systems, or perform network-based interactions and other transactions.

Wearable devices are a category of mobile devices. A wearable device is essentially a mobile device, but has a form-factor that is suitable for wearing the device on a user's person. A user can wear such a device as an article of clothing, clothing or fashion accessory, jewelry, a prosthetic or aiding apparatus, an item in an ensemble carried by or with a person, an article or gadget for convenience, and the like. Some examples of presently available wearable devices include, but are not limited to, smart watches, interactive eyewear, devices embedded in footwear, headgear or headwear mounted devices, devices wearable as rings or pendants, and pedometers and other clip-ons.

Customer service is a key distinguishing factor amongst competitors in the general food service industry, and particularly in the restaurant industry. The better a food service establishment is able to identify a customer/user's needs or preferences about food service, the higher is the likelihood of repeat business and/or increased sales from the user.

Users visit food service establishments under a variety of circumstances. A user might visit a food service establishment for casual dining, celebrations, get-togethers, special occasions, cultural observances, and many other circumstances. A circumstance is also often defined by the company or the co-participants who are present with the user. For example, in some circumstances the user might visit the food service establishment alone, whereas the user may be accompanied by friends, family members, co-workers, and users in other roles in other circumstances.

### SUMMARY

The illustrative embodiments provide a method, system, and computer program product. An embodiment includes a method that analyzes, using a processor and a memory, a muscle movement data collected from a user at a location using a sensor, to determine a pattern of movement. The embodiment correlates the pattern of movement to a manner of using a dinnerware. The embodiment calculates a set of aspects, the set of aspects being indicative of a circumstance of using the dinnerware. The embodiment constructs a preference profile for the user, the preference profile comprising an identity of the user, an identifier associated with the dinnerware, and the set of aspects. The embodiment updates a knowledgebase of preference profiles, wherein the knowledgebase is configured to predict a dinnerware preference of the user during a future dining circumstance of the user.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for predictive customization of food service operations through visualized service settings in accordance with an illustrative embodiment;

FIG. 4 depicts a block diagram of an example visualization of dinnerware preference in accordance with an illustrative embodiment;

FIG. 5 depicts a flowchart of an example process for constructing a knowledgebase in accordance with an illustrative embodiment; and

FIG. 6 depicts a flowchart of an example process of predicting the dinnerware preference in accordance with an illustrative embodiment.

### DETAILED DESCRIPTION

The illustrative embodiments recognize that different uses have different expectations, preferences, or choices about how they want to be served at the food service establishment. For example, one user may prefer having a fork placed at the user's setting because the user prefers eating noodles with a fork; similarly, another user might prefer having a spoon at the user's place setting, and another user might prefer having chopsticks for the same purpose.

As another example, one user may like to use small plates so as to not over eat, and another user may like to use large plates to fit as much food as possible. Similarly, the size of cup or bowl or another utensil is something that may vary based on the eating styles or preferences of different users. For example, a bowl of soup placed on the table while eating can be a large bowl, whereas a small bowl is preferred when the bowl is to be held close to the mouth, as in some cultures.

As some other examples, some users prefer a small glass for one beverage, and a large glass for another beverage. Generally, a type of container or utensil to be used with different foods or beverages can also be a personal preference, which can differ from user to user. For example, some users prefer stemware for a beverage, whereas other users may prefer mugs to hold by the handle, and some other users might prefer a high ball glass for the same beverage, all dependent upon how each user prefers to hold their containers or utensils.

Personal preferences also involve the manner of service of food. For example, some users prefer that a waiter serve the food items, whereas other users may prefer self-service. Even for the self-service, some users may prefer a heavy spoon and other users may prefer a lighter spoon while serving or eating any food items.

The illustrative embodiments recognize that a user's expectations, preferences, or choices in how the user wants to receive the food service vary depending upon the circumstance of a visit to a food service establishment. For example, assume that user Joe Q. is a regular patron of a food service establishment that serves Italian cuisine. When Joes dines out with his friends for an Italian cuisine dinner, he chooses to eat his food with a fork and prefers drinking his beverage from a pint glass. When Joe goes to an Italian cuisine dinner with his spouse and children, he uses fork but prefers drinking bottled water, and small glass of another beverage. When Joe goes to an Italian cuisine dinner for Italian with his extended family, e.g., his parents or relatives, he prefers using a fork and a spoon to eat his spaghetti, e.g., to twist pasta as a cultural choice, and drinks a social beverage from a large stemware.

As can be seen, the variations in circumstances of a user's visit to a food service establishment are closely associated with the user's preferences for how the user wants to receive the service at the food service establishment. The illustrative embodiments recognize that while some aspects of the circumstances of a visit can be captured manually, not all preferences are overtly discernible during the visit. For example, while a waiter at the food service establishment may be able to establish that the user is accompanied by extended family or friends, the waiter is often unable to discern whether the user prefers forks or spoons, unless the user or the waiter expressly asks. The illustrative embodiments recognize that a user is likely to be pleased with the service to a far greater degree when his preferences are automatically recognized at the food service establishment as opposed to when the user has to specify every preference each time.

The illustrative embodiments recognize that the presently available tools or solutions do not address these needs or provide adequate solutions for these needs. The illustrative embodiments used to describe the invention generally address and solve the above-described problems and other problems related to predictive customization of food service operations through visualized service settings.

An embodiment can be implemented as a software application. The application implementing an embodiment can be configured as a modification of an existing food service management system—such as an order taking system used by a food service establishment, as a separate application that operates in conjunction with an existing food service management system, a standalone application, or some combination thereof.

Only as some non-limiting examples, and not to imply any limitations in the illustrative embodiments, the embodiments are described with respect to dinnerware, and preferences related to dinnerware, in a food service establishment. From this disclosure, those of ordinary skill in the art will be able to conceive many other food service preferences that are discernible in a similar manner by adapting an embodiment to such other preferences. Such adaptations are contemplated within the scope of the illustrative embodiments.

A user who visits a food service establishment is equipped with a device that is capable of tracking muscle movements and capturing muscle movement data. Many wearable devices are presently available, which are capable of measuring minute muscle movements. Generally, a device associated with the user may be a mobile device, including but not limited to a wearable device.

The user's device is location-capable, i.e., is capable of determining the user's location in a geographical space and of determining that the location is a food service establishment when the user brings the device to the food service establishment. The device may be, but need not necessarily be, further capable of detecting audible signals, such as user's speech or conversation.

The food service establishment has a food service management system. A food service management system can include, but is not limited to a portable or wearable computing platform using which food service personnel can collect food order data, table configuration, dining party information, dining occasion information, reservation information, point of sale information, or some combination of these and/or other functions common to food service establishments. As some non-limiting examples, a food server may be equipped with a tablet computer, which may operate as a food service management system to perform these and other food service-related functions. A wearable device, such as an augmented reality eyewear device can also operate as a food service management system to perform these and other food service-related functions.

A food service management system collaborates with a remote system, such as a server data processing system accessible over a data network, in which an embodiment is implemented. Such a collaboration between a food service management system and an embodiment can be directly between the food service management system and the embodiment, or though one or more intermediary systems. For example, the food service management system may communicate with a restaurant reservation system (or a point of sale system, or another system at the food service establishment), which in turn communicates with the embodiment.

One embodiment can be configured such that one or more food service management system of a particular food service establishment collaborate with the embodiment. Another embodiment can be configured such that one or more food service management system of a plurality of locations of a food service establishment collaborate with the embodiment. Another embodiment can be configured such that one or more food service management system of one or more locations of a plurality of food service establishments collaborate with the embodiment.

An embodiment receives from a user's device the user's identifying information, the user's location at a food service establishment, and muscle movement data. The embodiment analyzes the muscle movement data to determine a pattern in the movements. The embodiment relates a pattern of movement to a dinnerware item, where the user using the dinnerware item causes the muscle movements in that pattern.

The food service management system, the audible signals captured by the user's device, or some combination thereof, provides data about the circumstance of the user's visit to the food service establishment. For example, the food service management system may expressly specify to the embodiment that the user is with a group (or alone), the group appears to be a group of friends (or family), the occasion appears to be casual (or a celebration), etc. Similarly, Natural Language Processing (NLP) of the audio data captured by the user's device may provide similar information as well.

The embodiment constructs a profile of the user using the user's identity, user's muscle movement pattern, corresponding dinnerware item, and circumstance information. If a profile of the user already exists for similar pattern, dinnerware item, and circumstance, the embodiment updates the existing profile with the new information from the current visit.

During a visit, when the identifying information, the muscle movement data, and the circumstance information are analyzed at an embodiment, the embodiment may find that a profile already exists for similar pattern and circumstance for the user. In such a case, the embodiment selects the existing profile and identifies the dinnerware item corresponding to the pattern and the circumstance for the user. The embodiment constructs visualization information from the data about the dinnerware item and sends the visualization information to a food service management system at the food service establishment.

When an existing profile is reused to identify a dinnerware item preference, there is only a certain degree of confidence in identifying that dinnerware item preference. As the reuse of the existing profile increases, the confidence in making the prediction that the user will prefer the identified dinnerware item under the circumstance also increases.

An embodiment computes a confidence value each time the embodiment determines that the circumstance of the user's presence at a food service establishment matches a profile of the user. The embodiment outputs the identified dinnerware item preference with the computed confidence value to the food service management system at the food service establishment where the user is visiting.

For example, the embodiment constructs a particular manner of graphically or textually presenting the dinnerware item data at the food service management system. One non-limiting example of the visualization may be a textual or iconic list of dinnerware item or items corresponding to a position of the user that is identified on the food service management system. A food service person, such as a waiter, can then visually see the dinnerware item preference of the user at that position on the table, and set the dinnerware item as a preferred service item for the user at that position.

Over time, data of different patterns and circumstances is analyzed relative to one or more users to build up a knowledgebase of profiles. A user can have several profiles, such as for different circumstances, alternative dinnerware item preferences for the same circumstance, same or different preferences for different food service establishments or food service establishment locations, and many other variations.

An embodiment allows a food service establishment to configure sharing restrictions of the portions of the knowledgebase that relate to the users' preferences at the food service establishment. For example, one food service establishment may configure a sharing restriction that restricts the sharing of such a portion of the knowledgebase with only some locations of the food service establishment. As another example, another food service establishment may configure a sharing restriction that restricts the sharing of such a portion of the knowledgebase with only some other food service establishments. As another example, another food service establishment may configure a sharing restriction that restricts the sharing of such a portion of the knowledgebase with some or all locations of some or all food service establishments that subscribe to the knowledgebase.

The manner of predictive customization of food service operations through visualized service settings described herein is unavailable in the presently available methods. A method of an embodiment described herein, when implemented to execute on a device or data processing system, comprises substantial advancement of the functionality of that device or data processing system in improving customer service at food service establishments by predictively adjusting a place setting for a user according to the user's circumstance of visit to the food service establishment.

The illustrative embodiments are described with respect to certain types of dinnerware items, muscle movement data, occasions, circumstances, preferences, profiles, confidence values, presentation or visualization, predictions, restrictions, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

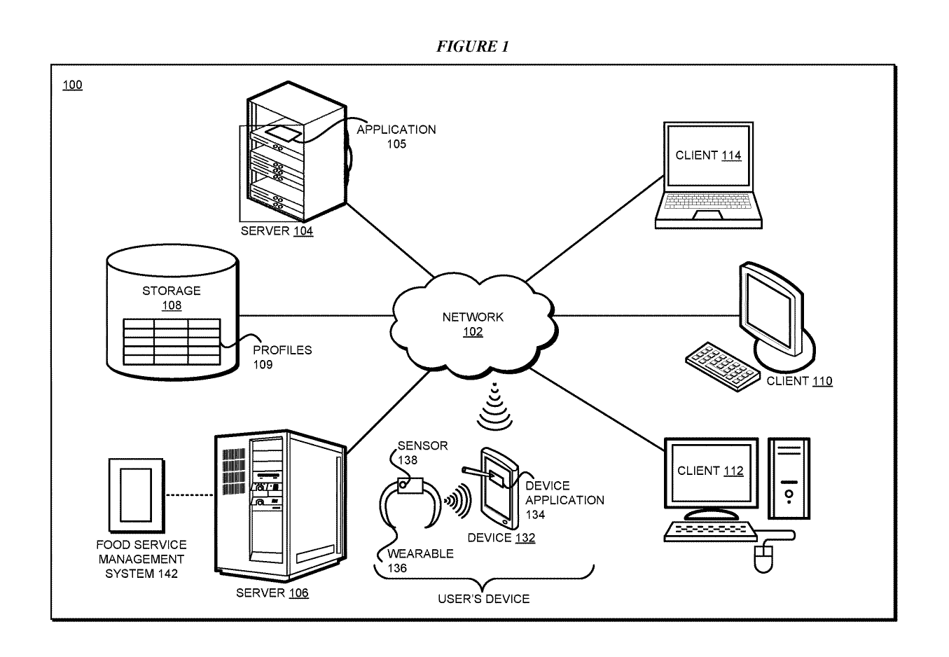

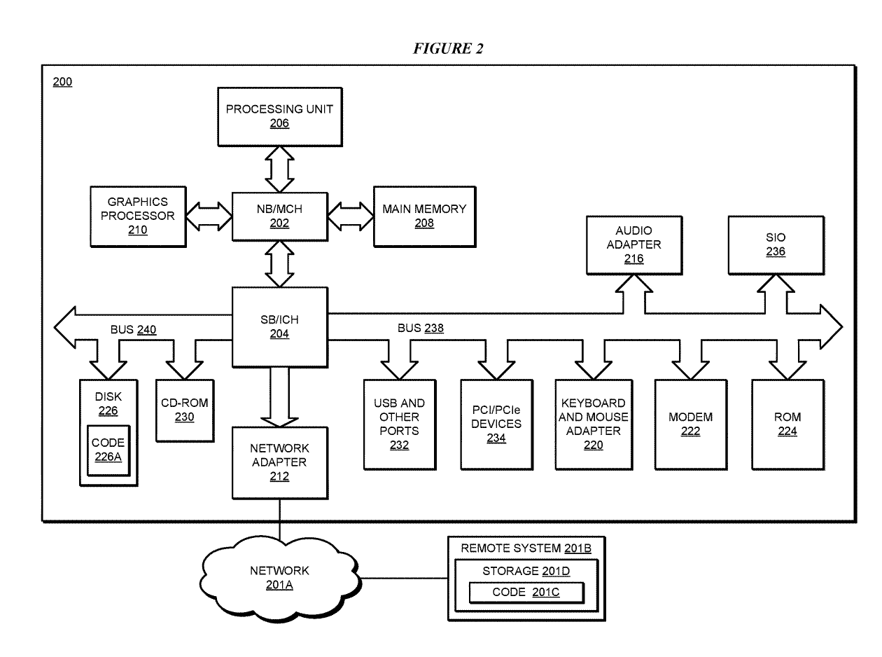

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 constructs and uses profiles 109 for predicting a user's dinnerware preferences during a visit to a food service establishment, as described herein. Device 132 is a device associated with the user. Device application 134 is an app that communicates the muscle movement data, the identity data, the location data, and the circumstance data—if so configured, to application 105. As a non-limiting example, wearable device 136 may be a smartwatch type of a device, in which sensor 138 captures the muscle movement data. As depicted, a non-limiting configuration causes the data captured by sensor 138 to be communicated to application 105 via app 134. Food service management system 142 is a device capable of visualizing the preference information for a food service worker, as described herein. As a non-limiting example, food service management system 142 may be table computer, which communicates with server 106—which may be a restaurant system, and which communicates with application 105 as described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

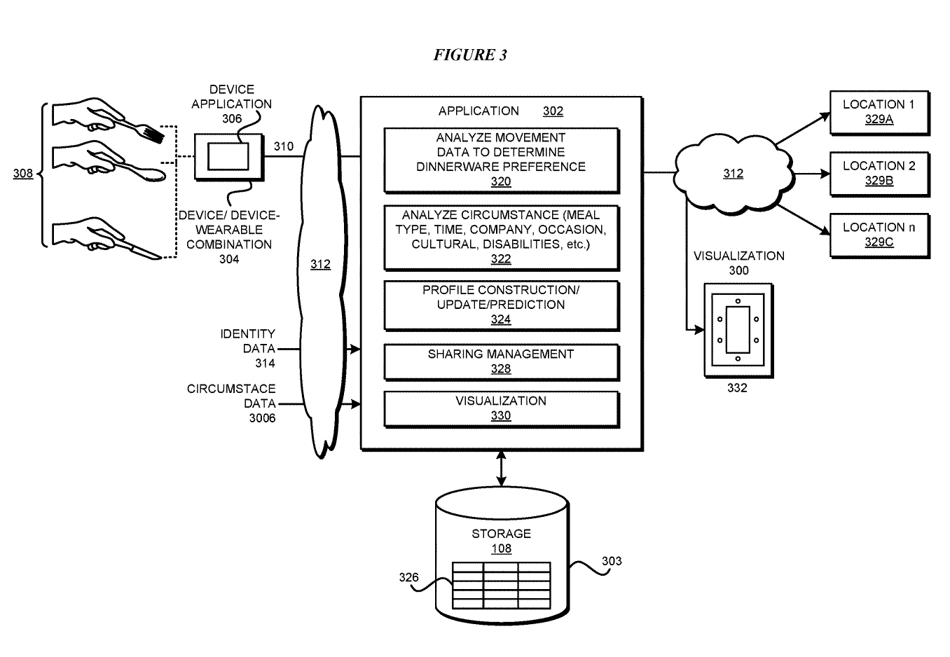

With reference to FIG. 3, this figure depicts a block diagram of an example configuration for predictive customization of food service operations through visualized service settings in accordance with an illustrative embodiment. Application 302 is an example of application 105 in FIG. 1. Device 304 is an example of device 132, wearable device 136, or some combination thereof from FIG. 1. Device application 306 executes on device 304 and detects the muscle movements caused by manipulations 308 of one or more dinnerware items, such as items of cutlery, utensils, glassware, and the like.

In one mode of operation, a profile for a user is constructed or updated in knowledgebase 303. In this mode, device application 308 captures muscle movement data 310 from manipulations 308, and delivers data 310 as input to application 302 over data network 312. Network 312 is an example of network 102 in FIG. 1. Device 304 or another source, such as a system at the food service establishment where device 304 is present with the user, supply identity data 314 and circumstance data 316 as additional inputs to application 302 over network 312.

Component 320 identifies the user using identity data 314. Component 320 analyzes muscle movement data 310 to determine the identified user's dinnerware preference.

Component 322 analyzes circumstance data 316 to determine a circumstance of the visit of the identified user at the food service establishment. For example, component 322 determines one or more of a type of meal, a time of a meal, person(s) accompanying the user, an occasion related to the meal, a cultural significance of the meal, a disability of the user to be considered for the meal, and the like.

Using the preference identified by component 320 and the circumstance determined by component 322, component 324 constructs profile 326, or updates profile 326, as described herein.

In another mode of operation, knowledgebase 303 is used to predict a user's dinnerware preference. For example, when inputs 314 and 316 are available, but not data 310, component 324 predicts the dinnerware that the identified user will likely want to use under the determined circumstance. To make the prediction, component 324 uses profile 326, which has previously been constructed for the determined circumstance of the identified user according to the mode of operation previously described.

Note that it is not necessary that profile 326 be constructed for the food service establishment where the user is currently visiting, in order to make the prediction in this mode. Profile 326 can be constructed for one food service establishment and can be used to make a prediction during a visit at another food service establishment if component 328 determines that such a sharing of profile 326 from knowledgebase 303 is permitted according to a sharing restriction.

For example, component 328 may determine that profile 326 is sharable with locations 329A, 329B, and 329C. Locations 329A-C may include a location, e.g., location 329A, which may be a location or food service establishment where data for constructing profile 326 was originally collected or updated. Locations 329A-C may alternatively be locations of food service establishments different from the location or food service establishment where data for constructing profile 326 was originally collected or updated. Sharing of predictions—with the confidence level information and in the visualization form as described herein—with locations 329A-C, occurs over data network 312 as well.

In making the prediction about the dinnerware that the user is likely to prefer under the determined circumstance, component 324 also computes a confidence value associated with that prediction, as described herein. Component 330 converts, adapts, or otherwise manipulates the data indicative of the predicted dinnerware and the corresponding confidence level into information that is usable to visualize the preference. For example, the visualization information is sent to food service management system 332, which presents a textual or graphical visualization of the preference and the confidence level, as described herein. Food service management system 332 is an example of food service management system 142 in FIG. 1, and may operate in any of locations 329A-C or another location.

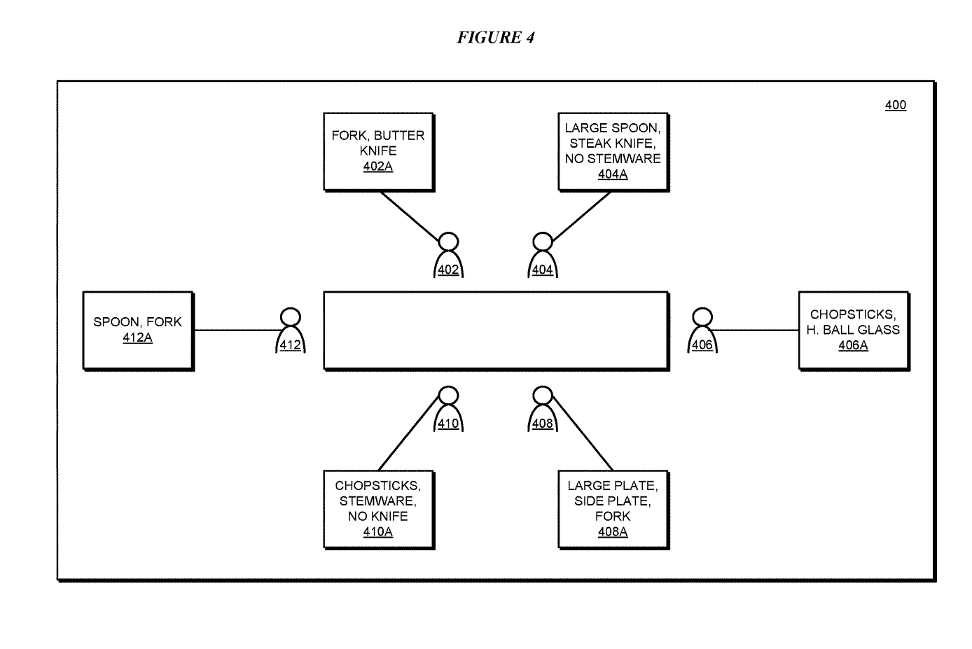

With reference to FIG. 4, this figure depicts a block diagram of an example visualization of dinnerware preference in accordance with an illustrative embodiment. Visualization 400 can be constructed using the visualization information produced from component 330 in FIG. 3, and on food service management system 332 in FIG. 3.

Assume, as an example, that the circumstance of the visit to the food service establishment involves a group of users 402, 404, 406, 408, 410, and 412. Application 302 can produce visualization information for one or more of users 402-412. Assume, as an example, that the preferences of users 402-412 is available from application 302 in FIG. 3 and is presented in the non-limiting example manner as depicted in FIG. 4.

A food service worker can visualize each user 402-412 via some graphical or textual representation at a table setting. Visualization 400 depicts, relative to each visualized user 402-412, the user's predicted dinnerware preference. For example, user 402 has the predicted preference for a fork and a butter knife, as visualized in example bubble 402A relative to user 402. Similarly, user 404 has certain other predicted preferences as visualized in example bubble 404A relative to user 404; user 406 has certain other predicted preferences as visualized in example bubble 406A relative to user 406; user 408 has certain other predicted preferences as visualized in example bubble 408A relative to user 408; user 410 has certain other predicted preferences as visualized in example bubble 410A relative to user 410; and user 412 has certain other predicted preferences as visualized in example bubble 412A relative to user 412.

The confidence levels associated with each predicted dinnerware preference can be depicted (not shown) in any suitable manner. For example, one non-limiting manner of visualizing the confidence level associated with a prediction, e.g., with the fork prediction in bubble 402A, might be color coding the font of the prediction text or icon “fork” where the color is indicative of the confidence level. E.g., green font or icon representing “fork” preference could indicate greater than ninety percent confidence, red font or icon representing “fork” preference could indicate less than fifty percent confidence, and other colors could indicate other confidence values in a similar manner. Other visualizations, such as bars of various sizes, arcs of various sizes or colors, dots in different numbers colors or sizes, and many other visualizations of the confidence values will be conceivable from this disclosure and the same are contemplated within the scope of the illustrative embodiments.

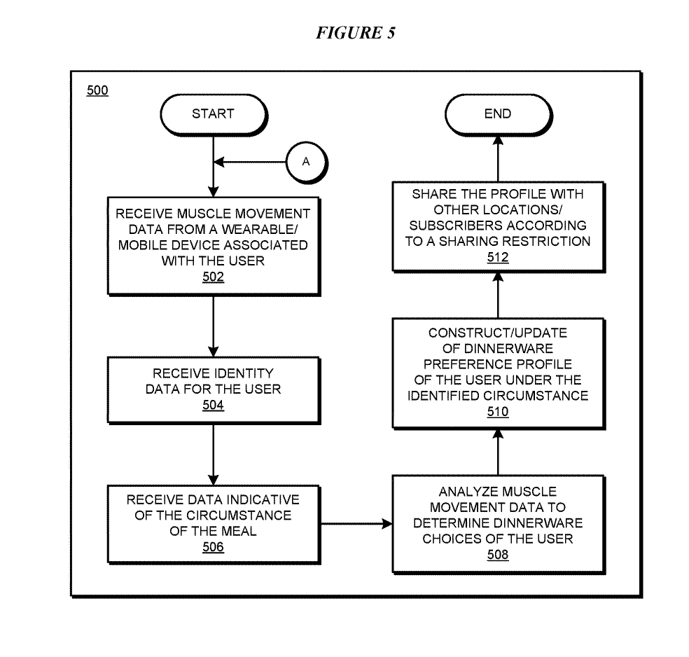

With reference to FIG. 5, this figure depicts a flowchart of an example process for constructing a knowledgebase in accordance with an illustrative embodiment. Process 500 can be implemented in application 302 in FIG. 3.

The application receives muscle movement data from a device associated with a user (block 502). The application receives identifying information about the user (block 504). The application also receives data usable to compute one or more aspects of a circumstance of a visit to a food service establishment by the user (block 506).

The application analyzes the muscle movement data to determine a type of dinnerware item being used by the user (block 508). The application constructs a new dinnerware preference profile for the user—if one does not already exist corresponding to the aspects of the circumstance of the visit (block 510). If a profile already exists corresponding to the aspects of the circumstance of the visit the application updates the profile in block 510.

Depending upon a sharing restriction or permission configured for the profile, the application shares the profile with one or more locations of the food service establishment and/or other food service establishments (block 512). The application ends process 500 thereafter.

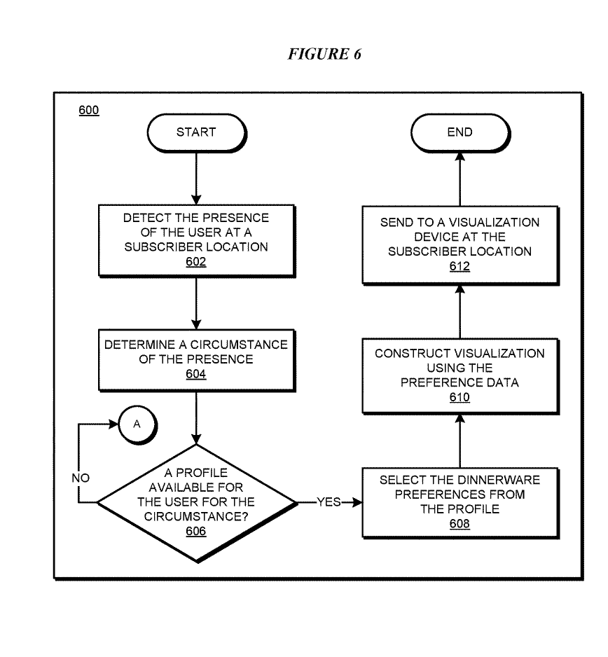

With reference to FIG. 6, this figure depicts a flowchart of an example process of predicting the dinnerware preference in accordance with an illustrative embodiment. Process 600 can be implemented in application 302 in FIG. 3.

The application detects a presence of an identified user at a food service establishment location that subscribes to the knowledgebase constructed in process 500 of FIG. 5 (block 602). The application determines one or more aspects of circumstance of the user's visit to the food service establishment location (block 604).

The application determines whether a profile is available for the identified user of the circumstance that presently exist for the user's visit to the food service establishment location (block 606). If a profile does not exist (“No” path of block 606), the application exits process 600 at exit point “A” and enters process 500 at entry point “A”.

If a profile does exist for the circumstance (“Yes” path of block 606), the application selects the dinnerware preference from the profile (block 608). The application constructs information usable for visualizing the preference (block 610). Optionally, when so configured, the application can also compute a confidence value of the predicted preference and add the confidence value to the visualization. Note that the confidence value calculation is not necessary for the operation of an embodiment.

The application sends the visualization information to a food service management system at the food service establishment location (block 612). The application ends process 600 thereafter.

Thus, a computer implemented method, system or apparatus, and computer program product are provided in the illustrative embodiments for predictive customization of food service operations through visualized service settings and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
analyzing, using a processor and a memory, a muscle movement data collected from a user at a location using a sensor, to determine a pattern of movement;
correlating the pattern of movement to a manner of using a dinnerware;
calculating a set of aspects, the set of aspects being indicative of a circumstance of using the dinnerware;
constructing a preference profile for the user, the preference profile comprising an identity of the user, an identifier associated with the dinnerware, and the set of aspects; and
updating a knowledgebase of preference profiles, wherein the knowledgebase is configured to predict a dinnerware preference of the user during a future dining circumstance of the user.

2. The method of claim 1, further comprising:
detecting a presence of the user at a second location;
computing a second set of aspects of a second circumstance of the presence at the second location;
evaluating that the set of aspects of the circumstance in the preference profile shares at least a subset of aspects with the second set of aspects of the second circumstance;
extracting, from the preference profile, the identifier of the dinnerware; and
presenting a visualization of the dinnerware at a food service management system located at the second location.

3. The method of claim 2, wherein the location is the second location.

4. The method of claim 2, further comprising:
determining that a sharing permission is configured to allow using the preference profile with the second location, wherein a food service establishment associated with the location is distinct from a second food service establishment associated with the second location.

5. The method of claim 2, further comprising:
computing a confidence value relative to selecting the preference profile for the extracting; and
presenting, in the visualization, the confidence value.

6. The method of claim 1, wherein the set of aspects includes a role of a person accompanying the user during a presence of the user at the location.

7. The method of claim 1, wherein the set of aspects includes an occasion related to a presence of the user at the location.

8. The method of claim 1, wherein a second pattern of movement in a second muscle movement data relates to a manner of using a second dinnerware.

9. The method of claim 1, further comprising:
detecting that the user is present at the location; and
collecting the identifying information of the user and the muscle movement data during an initial presence of the user at the location.

10. A computer usable program product comprising one or more computer-readable storage devices, and program instructions stored on at least one of the one or more storage devices, the stored program instructions comprising:
program instructions to analyze, using a processor and a memory, a muscle movement data collected from a user at a location using a sensor, to determine a pattern of movement;
program instructions to correlate the pattern of movement to a manner of using a dinnerware;
program instructions to calculate a set of aspects, the set of aspects being indicative of a circumstance of using the dinnerware;
program instructions to construct a preference profile for the user, the preference profile comprising an identity of the user, an identifier associated with the dinnerware, and the set of aspects; and
program instructions to update a knowledgebase of preference profiles, wherein the knowledgebase is configured to predict a dinnerware preference of the user during a future dining circumstance of the user.

11. The computer usable program product of claim 10, further comprising:
program instructions to detect a presence of the user at a second location;
program instructions to compute a second set of aspects of a second circumstance of the presence at the second location;
program instructions to evaluate that the set of aspects of the circumstance in the preference profile shares at least a subset of aspects with the second set of aspects of the second circumstance;
program instructions to extract, from the preference profile, the identifier of the dinnerware; and
program instructions to present a visualization of the dinnerware at a food service management system located at the second location.

12. The computer usable program product of claim 11, wherein the location is the second location.

13. The computer usable program product of claim 11, further comprising:
program instructions to determine that a sharing permission is configured to allow using the preference profile with the second location, wherein a food service establishment associated with the location is distinct from a second food service establishment associated with the second location.

14. The computer usable program product of claim 11, further comprising:
program instructions to compute a confidence value relative to selecting the preference profile for the extracting; and
program instructions to present, in the visualization, the confidence value.

15. The computer usable program product of claim 10, wherein the set of aspects includes a role of a person accompanying the user during a presence of the user at the location.

16. The computer usable program product of claim 10, wherein the set of aspects includes an occasion related to a presence of the user at the location.

17. The computer usable program product of claim 10, wherein a second pattern of movement in a second muscle movement data relates to a manner of using a second dinnerware.

18. The computer usable program product of claim 10, wherein the computer usable code is stored in a computer readable storage device in a data processing system, and wherein the computer usable code is transferred over a network from a remote data processing system.

19. The computer usable program product of claim 10, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to analyze a muscle movement data collected from a user at a location using a sensor, to determine a pattern of movement;
program instructions to correlate the pattern of movement to a manner of using a dinnerware;
program instructions to calculate a set of aspects, the set of aspects being indicative of a circumstance of using the dinnerware;
program instructions to construct a preference profile for the user, the preference profile comprising an identity of the user, an identifier associated with the dinnerware, and the set of aspects; and
program instructions to update a knowledgebase of preference profiles, wherein the knowledgebase is configured to predict a dinnerware preference of the user during a future dining circumstance of the user.
